(19) United States
(12) Patent Application Publication
(10) Pub. No.: US 2017/0323439 A1
(43) Pub. Date: Nov. 9, 2017

(54) System And Method For Functional Reconstruction Of Integrated Circuits From Layout Analysis Of Circuit Images

(71) Applicant: ROCCOR, LLC, Louisville, CO (US)

(72) Inventors: Hans Kristian Sandberg, Boulder, CO (US); Dixon Chen Dick, Longmont, CO (US); Gary L. Duerksen, Ward, CO (US)

(21) Appl. No.: 15/148,763

(22) Filed: May 6, 2016

(51) Int. Cl. G06T 7/00; G06F 17/50; G06K 9/46

(52) U.S. Cl. CPC G06T 7/0006; G06K 9/4604; G06F 17/5077; G06T 2207/30148

(57) ABSTRACT

A method for reverse engineering the layout structure of an integrated circuit includes providing an image of a layer of the integrated circuit; processing the image to identify differentiated regions; associating the differentiated regions; and deriving a functional relationship between the association of the differentiated regions.

### GOVERNMENT RIGHTS

This invention was made with government support under contract number W911NF-15-C-0009-P00003 Phase II SBIR, awarded by US Army. The government has certain rights in the invention.

### BACKGROUND

The present disclosure relates to structural and functional analysis of integrated circuits in order to reconstruct the high-level circuit design and reverse engineer the circuit function for forensic purposes. Semiconductor devices are commonly very complex and may contain billions of transistors and billions of interconnects between those transistors which define the structure and functionality of the device. The complexity of the device does not readily allow determination of the authenticity or provenance of the device, nor does it permit investigation of the details of the device function and/or design which may enable recognition of intentionally modified and/or counterfeit devices.

Prior art methods of detecting counterfeit circuits have, for example, been based upon visual inspection of the circuit design following decapsulation of the integrated circuit to the die surface. This technique enables topside analysis of the finished die as it appeared before packaging, which reveals only the large-scale architecture of the circuit design and wire-bond pinouts. For conventional anti-counterfeiting applications, this level of analysis may be sufficient to detect counterfeit integrated circuits. Typically, fabricators of counterfeit chips only attempt to substitute another integrated circuit that is functionally similar to an authentic integrated circuit by mimicking the packaging of the authentic chip. This substitution is performed either during the actual die level manufacturing process, or a second-party agent may re-brand some other chip through techniques such as repackaging or blacktopping and remarking and substitute it as the authentic device. However, the underlying integrated circuit architecture still conforms to the substitute manufacturer's circuit design, which is distinct from the authentic design.

An instance of this substitution-type of counterfeiting was provided in association with the FTDI FT232RL communication chip, for which a counterfeiter produced a functionally equivalent integrated circuit device that was packaged to look like the original. Cursory inspection of the integrated circuit of the decapsulated FTDI chip versus the decapsulated counterfeit integrated circuit reveals obvious high-level large-scale structural differences in architectures that are sufficient to distinguish the two integrated circuits by-eye, using ordinary microscopic images of the decapsulated integrate circuit die. FIGS. 1A and 1B are block diagram images of the abovementioned authentic (FIG. 1A) and counterfeit (FIG. 1B) integrated circuits showing easily identified and discriminated large scale structures of the die layout.

A very different situation arises when an integrated circuit has been cloned, meaning that either the lithography masks for the integrated circuit have been replicated, permitting reproduction of the integrated circuit at another foundry employing a similar fabrication process (a hard clone), or the high-level logical design of the integrated circuit has been pirated, permitting production of a functional copy of the circuit using any fabrication process (a soft clone). High-value targets for cloning are semiconductor intellectual property cores (“IP cores”) which represent a range of proprietary circuit designs of logic cells, memory structures and hardware instantiations of complex source-code designs for both standard processes and highly specialized processing capabilities.

Detection of cloned functionality poses different challenges from counterfeit detection because the cloned core may be embedded in an otherwise legitimate integrated circuit, or licensed functionality may have been altered to infiltrate malicious functionalities into a trusted design. Therefore, in order to detect cloned or modified functionality and identify the foundry where the integrated circuits were fabricated, new enabling capabilities are required. There thus remains a significant need for new reconstruction and reverse engineering techniques which quickly and accurately characterize integrated circuit internal structures and identify their function.

### SUMMARY

In an embodiment, a method of identifying layout-functional relationships of an integrated circuit includes (a) providing a first image of at least a portion of a first layer of the integrated circuit, (b) processing the first image to identify at least two differentiated regions, (c) associating the differentiated regions, and (d) inferring at least one layout-functional relationship between the associated differentiated regions.

In an embodiment, a system for reverse engineering an integrated circuit includes an imaging system configured to collect an image of the integrated circuit, and a processor configured to (a) identify at least two differentiated regions of the image, (b) associate the differentiated regions, and (c) infer at least one layout-functional relationship between the associated differentiated regions.

In an embodiment, a method for determining provenance of an integrated circuit includes (a) providing an image of at least a portion of a layer of the integrated circuit, (b) processing the image to identify at least two differentiated regions, (c) extracting at least one of foundry, design rule and functional information from analysis of associations of the differentiated regions, and (d) comparing the extracted information with a predetermined set of references.

### BRIEF DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

FIGS. 1A and 1B show outlines of circuit blocks in images of an integrated circuit showing easily identified and discriminated large scale structures of the die layout, in accordance with an embodiment.

FIGS. 2A and 2B are portions of the images of integrated circuit of FIGS. 1A and 1B showing details of portions of two different large scale structures, in accordance with an embodiment.

FIG. 3 is a flow chart of a process for identifying layout-functional relationships of an integrated circuit, in accordance with an embodiment.

FIGS. 4A-C are images of portions the first metallization layer of an integrated circuit indicating processing steps in identifying layout-functional relationships of the integrated circuit, in accordance with an embodiment.

FIG. 5 is a flow chart of a process for identifying and tokenizing layout-functional relationships of an integrated circuit, in accordance with an embodiment.

FIG. 6 is a flow chart further detailing a process for tokenizing layout-functional relationships of an integrated circuit, in accordance with an embodiment.

FIGS. 7A-D are a set of images representing stages of the vectorizing process of FIG. 6, in accordance with an embodiment.

FIGS. 8A-B are graphical and tabular representations of the results of the vectorization process of FIG. 6, in accordance with an embodiment.

FIG. 9A is a set of tokens representing shapes identified in the image of the integrated circuit of FIG. 4A. FIG. 9B is the tokenized image of the integrated circuit of FIG. 4A denoting locations and orientations of only the first identified shape, in accordance with an embodiment.

FIG. 10 is a flow chart of a process for identifying and tokenizing hierarchical layout-functional relationships of an integrated circuit, in accordance with an embodiment.

FIG. 11A is a set of token pairings identified from the tokenized image of the integrated circuit of FIG. 4A. FIG. 11B is the re-tokenized image of the integrated circuit of FIG. 4A indicating locations and orientations of only the first identified token pairs, in accordance with an embodiment.

FIG. 12A is a set of higher-order token groupings identified from the tokenized representation of the integrated circuit of FIG. 4A. FIG. 12B is the re-tokenized representation of the integrated circuit of FIG. 4A indicating locations and orientations of only the first identified higher-order token grouping, in accordance with an embodiment.

FIG. 13A is the final token grouping identified from the image of the integrated circuit of FIG. 4A. FIG. 13B is the re-tokenized image of the integrated circuit of FIG. 4A denoting locations and orientations of only the final token grouping of FIG. 13A, in accordance with an embodiment.

FIG. 14A is an image of tokens identified from the image of the integrated circuit of FIG. 4A representing primitive interconnect elements. FIG. 14B is the image of FIG. 13B repeated here for convenience of comparison to associated images. FIG. 14C is an image of the final token grouping combined with the tokens for the associated primitive interconnect elements, in accordance with an embodiment.

FIG. 15A is the tokenized representation of the integrated circuit of FIG. 4A denoting locations and orientations of only a second final token grouping identified from the tokenized representation of circuit 4A. FIG. 15B is a union of the images of FIGS. 13B and 15A showing the spatial relationships amongst the two identified final token groupings, in accordance with an embodiment.

FIGS. 16A-D are images of portions of successive metallization layers of an integrated circuit indicating processing steps of identifying routing-layout relationships of the integrated circuit, in accordance with an embodiment. The termini of the differentiated regions in the images of these layers may be linked to the vias in the first metallization layer shown in FIG. 4C and described herein, in accordance with an embodiment.

FIG. 17 is block diagram of major system elements of an exemplary reverse engineering system, in accordance with an embodiment.

### DETAILED DESCRIPTION OF ILLUSTRATED EMBODIMENTS

The current invention provides the capability to reconstruct and/or reverse engineer the functional design of an integrated circuit starting from images of the circuit layout, as well as the ability to extract the design rules imposed on the integrated circuit by the foundry employed in its fabrication. The current invention provides these capabilities by, for example, constructively recapitulating the integrated circuit design procedure in reverse based on analysis of microscopic images at gate-level feature resolution of decapsulated, sectioned and/or delayered integrated circuits.

The modern industry practice for designing IP cores is to implement the fundamental logical or analog operations using a discrete set of building-block integrated circuit elements whose design adheres to a consistent form factor, facilitating a structured layout in which the elements are placed between uniformly spaced bus lines. The building-block integrated circuit elements are also commonly called standard cells. The layout of the standard cells—including but not limited to metallization line widths and spacing, enclosure placement, etc.—are derived from SPICE simulations of the physical circuit as fabricated in accordance with the process used by the foundry and are known as the foundry rules.

The library of standard cell designs, which implement in hardware the elemental operations used to construct an arbitrary high-level functional capability, plus the foundry rules, which dictate how the circuit designs must be laid out in order to meet performance specifications, together are called a Process Design Kit (PDK). The PDK bridges the gap between physical circuit design and the functional circuit design that is produced using a hardware description language (HDL) such as Verilog-AMS or VHDL.

The rendering of the desired high-level functional capability in an IP core in a hardware design proceeds by reducing the design function of the core to the elemental operations of standard cells. The reduction of design function to elemental operations is accomplished using a high-level design language, and the circuit design is rendered in terms of the standard cells using a logic synthesis tool combined with placement and routing software such as IC Compiler. The connections to the gates or other circuit components within a cell, and the interconnections between cells are fabricated on successive metallization layers in 3-dimensions, with an insulating material separating the layers and metal vias linking the layers.

Standard cells may perform digital and/or analog functions and their physical design may embody any semiconductor fabrication technology, such as complementary metal-oxide semiconductor (CMOS) for logic circuits and GaAs for high-speed RF circuits. The complexity of any standard cell may range from a simple logic element such as a simple NAND gate through more complex functions such as a binary multiplier. A full description of standard cell design methods may be found in the reference Characterization an Modeling of Digital Circuits by Rohit Sharma, CreateSpace Independent Publishing Platform, 2015.

The methods employed in the current invention to reconstruct the function of an integrated circuit parallel the steps of the standard-cell design methodology outlined above. Specifically, successive metallization layers of an integrated circuit may be imaged by decapsulation and delayering of the die, and the layout of the integrated circuit may be deduced incrementally from analysis of each successive metallization layer, beginning, for example, with the first metallization layer and proceeding through the succeeding metallization layers (typically three for a cell-based design). The first-layer metallization regions provide for gate-level interconnections within individual cells and connections between adjacent cells. Accordingly, the first metallization layer images provide both a proxy representation of the circuit layout of the standard cells and a description of the placement of cells on the die.

Reconstruction of the functional design of the circuit includes deriving the placement list of the standard cells; namely, the identities of the standard cells and their locations on the die. The reconstruction also includes deriving the routing list of interconnections (nets); namely connections between cells, their connections to signal leads, and the vias between layers. In combination, the list of routing information net and placement information constitutes the netlist for the circuit layout.

High-end semiconductor devices—particularly ASICs, CPLDs, and FPGAs—may contain proprietary circuit designs (IP cores) that represent a considerable investment in development costs and also may incorporate restricted technology. Unscrupulous vendors may clone the IP cores for unlicensed use and fabricate the ICs at an undetermined but established foundry, and hostile countries may acquire sensitive technology by cloning IP cores used in military electronics.

Accurate detection of cloned IP cores in integrated circuits requires that the functional design be reverse engineered. In practical terms, this entails reconstructing the netlist for the circuit, which includes the identities of the functional circuit elements (cells), their placement on the die, and the routing of interconnects among the cells. For a cloned hard core, the netlist itself is sufficient to identify an IP core; for a cloned soft core, the core's identity can be inferred by abstracting the high-level logic/operation design of the circuit from the netlist. Consequently, the problem of determining whether a chip incorporates unlicensed IP core designs may be solved by deducing the identities of the standard cells from their gate-level layout and extracting the placement of and routing between the cells.

When such chips are discovered—ICs that incorporate unlicensed IP cores—it is not readily apparent which foundry fabricated the illicit chips. However the fabrication process requires that the circuit design be implemented using a prescribed set of functional cell designs and a circuit layout; namely, a particular PDK that conforms to the manufacturing process of the foundry of origin. Knowledge of the PDK provides an identifying signature for the originating foundry. Thus, the problem of determining the source of an IC that contains unlicensed proprietary circuit designs may be reduced to the problem of characterizing the process design signature of the physical layout of the cloned circuit and identifying the foundry whose rules match that signature.

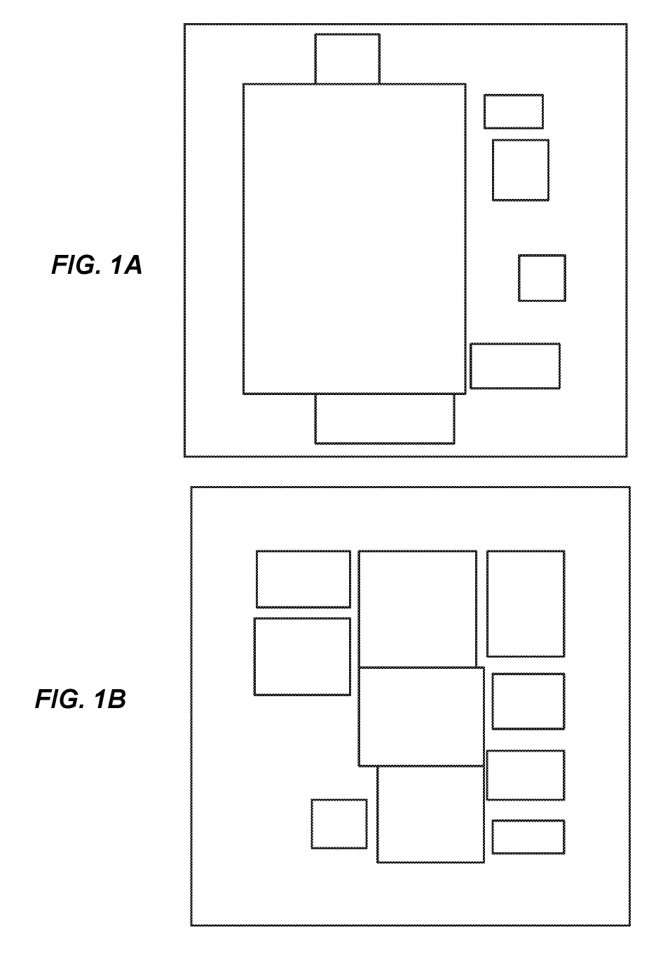

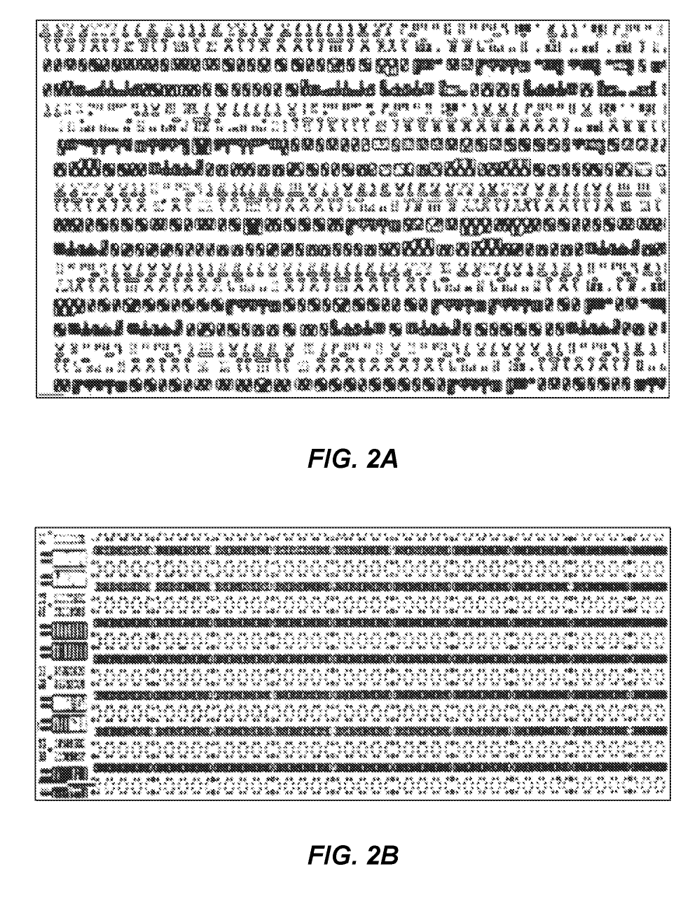

FIGS. 2A and 2B show images of portions of the image of the integrated circuit of FIG. 1B showing details of portions of two different macro-scale structures with differing standard cells and layout. FIG. 2A shows approximately 12 different standard cells arranged in a row layout. FIG. 2B shows a 2D array of SRAM cells formed from a much less complex set of elemental cells. Although cursory review of the image of the SRAM cells permits determination of the word-length and other higher level functionality of the SRAM, the determination of higher-level functionalities of the portion of integrated circuit shown in FIG. 2A requires more detailed hierarchical analysis.

As described herein, intellectual property cores occupy many different levels of integration and size scales, from macro-scale system-on-chip designs to meso-scale functional blocks to micro-scale units of elemental logic. The layout-functional relationship of an IP core design, including identification of individual standard cells and derivation of the function of circuit blocks, may be defined for entireties or portions of these integrated circuits at any scale from any type of device such as ASICs, DSPs, antifuse FPGAs, FPGAs containing hard IP cores or hard blocks, and any integrated circuit containing hard IP cores or hard blocks.

A simplified example of the hierarchical analysis of integrated circuits as provided by the current invention will be discussed below. This example depicts the simplified layout of a portion of an integrated circuit having three metallization layers that have been imaged via scanning electron microscopy (SEM), which differentiates metallization from the various dielectric and semiconductor materials present in the integrated circuit.

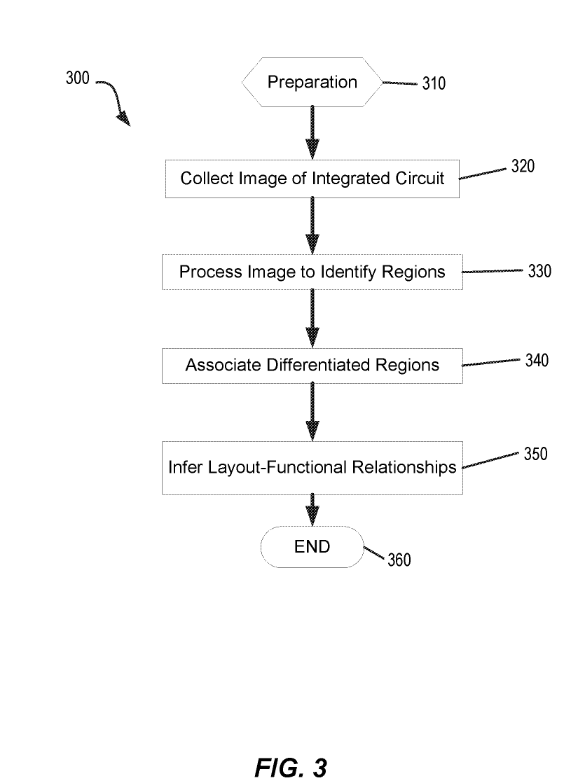

FIG. 3 is a flow chart of process 300 for identifying layout-functional relationships of an integrated circuit. Process 300 may be used to derive any or all of the hierarchy of information described in association with the procedure for analysis of integrated circuits as described herein. Process 300 initiates with step 310 wherein any necessary or optional setup and preparation steps may be performed which may include decapsulation and delayering of the die, determination of appropriate imaging technology and selecting the appropriate image magnification. Once any preparatory operations are completed, process 300 advances to step 320 wherein one or more images of the integrated circuit are collected, such as by using one or more imaging devices to capture the images. The selected imaging technology may permit capture of images at a resolution capable of resolving the differentiated regions of the integrated circuit on the scale of the lithographic process used in the fabrication of the integrated circuit.

Differentiated regions are portions of the integrated circuit, such as, but not limited to, metallized regions, doped regions, via regions, interlayer interconnects, intralayer interconnects, chemically differentiated regions, and regions differentiated by material that may be imaged to provide gray-scale or binary images useful for application of the current invention to identify the layout-functional relationships of the integrated circuit. Herein below, a detailed discussion of the processing of images of metallization layers will be described as exemplary of the current invention. Differentiated regions may be imaged by one or more methods to provide the images useful in the current invention. Suitable imaging technologies and techniques may include, but are not limited to, visible light images, NIR images, fluorescence images, SEM images, STM images, profilometer images, SIMS images, AFM images, e-beam images, and X-ray images. Although single image types may be suitable for practicing the current invention, it should be understood that multiple images and/or multiple image technology types may be combined to provide further details of the layout-functional relationships of an analyzed integrated circuit and may be processed in a fashion similar to those steps discussed herein as applied to SEM images of metallization layers.

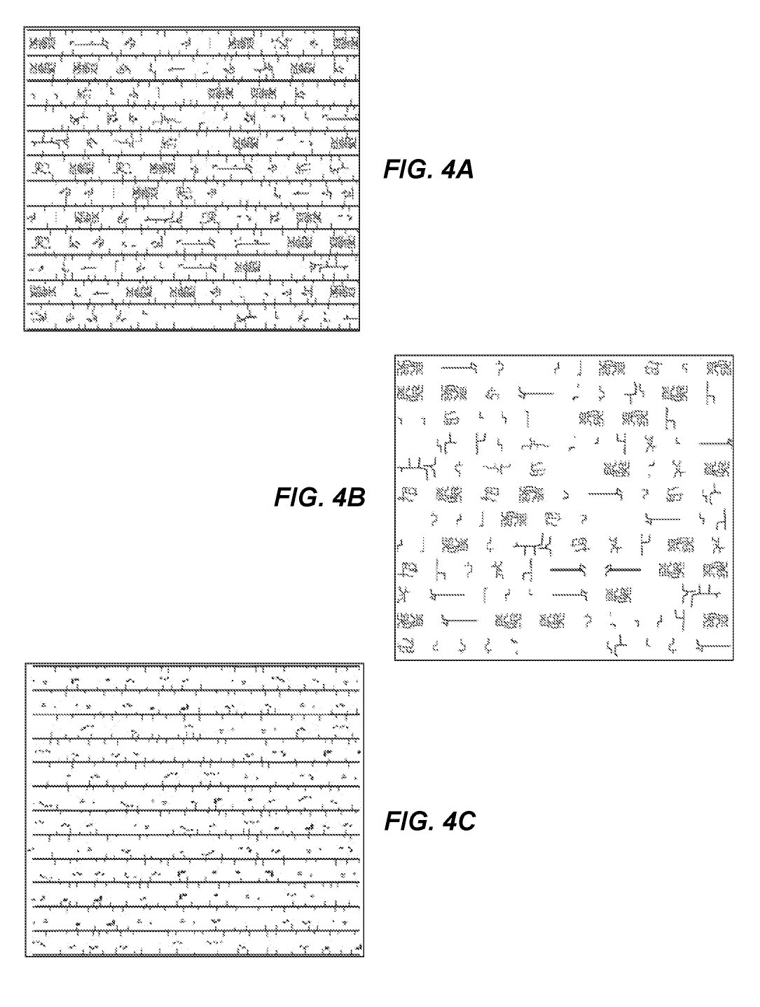

Within step 330 a collected image may be processed to identify differentiated regions. FIG. 4A shows an exemplary bitmapped SEM image of a portion of an integrated circuit which originally may have been collected as gray-scale and converted to binary based upon black-and-white thresholding or other suitable image processing techniques to roughly determine differentiated regions. For the current example of an SEM image of a metallization layer, the differentiated regions are separated into two classes: those regions containing metal and those regions which do not contain metal. In FIG. 4A those regions containing metal are shown in black whereas those regions not containing metal are shown in white. Gray-scale image processing may be used for more levels of differentiation, such as for doped regions which are commonly of multiple different dopant types and concentrations.

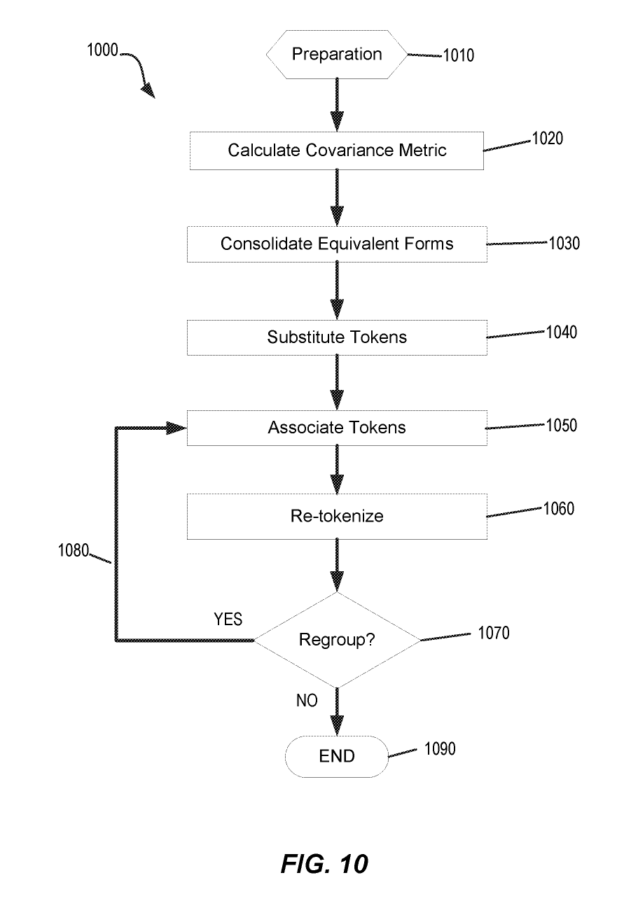

Once differentiated regions have been identified for one or more layers, process 300 advances to step 340 wherein the identified differentiated regions may be associated in functional groupings. Details of the steps of association are discussed herein with the description of process 1000 and FIGS. 10-15. In brevity, association is the process of identifying like differentiated regions and then hierarchically grouping spatially proximate regions whose grouping layout occurs repeatedly in the circuit. The final cell groupings may be tokenized by creating a unique symbolic representation for each distinct like-layout grouping. The tokens may serve as proxies for or identified with known or unknown, specific or undefined circuit operations, such as correspond to functions performed by standard cells, portions thereof or groups thereof. It should be recognized that associations may be formed within any single layer of the integrated circuit or may include multiple layers which may be spatially registered and interconnected by via structures or other interconnects.

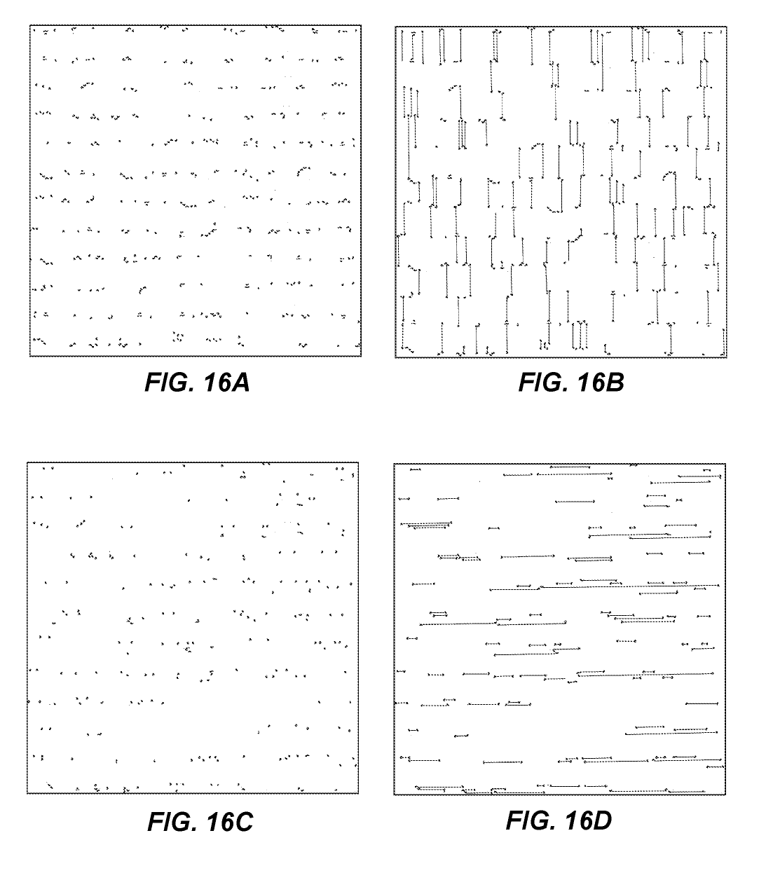

FIG. 4B shows the first step toward associating the layout of a differentiated region with an integrated-circuit function, which is to segment the image so as to remove the differentiated regions identified as power and ground busses, in-plane interconnects (filler cells) and vias—these differentiated regions exhibit topological characteristics such as size linearity and orientation that distinguish them from the differentiated regions affiliated within standard cells. The segmented image showing bus lines, vias and other interconnect structures appears separately in FIG. 4C and will be further discussed herein below in association with FIG. 16.

Following the procedure for associating differentiated regions into tokenized groupings, the relationship between the layout of the groupings and the function of the groupings may be inferred in step 350. Details of the step of inferring layout-functional relationships are discussed herein with the description of process 1000 and FIGS. 10-15. In brevity, inferring layout-functional relationships includes identifying individual and hierarchical spatial relationships in the layout of differentiated regions and associating those relationships with logical or analog functionalities such as those performed by a library of standard cells. Examples of such functionalities include, but are not limited to, NAND, NOR, NOT, and DFF operations, or peak detection, differential amplification or integration circuits. Process 300 terminates with step 360 wherein any finalizing process steps may be performed such as recording of any of the details of the previous steps of process 300 into a database structure for future recall. The layout of the standard cell designs (viz, the cell library) may be recorded using the syntax of a Cadence Library Exchange Format (LEF) file, for example, so as to be viewable using the Cadence Virtuoso layout editor.

The process of tokenizing the functional groupings of differentiated regions and identifying the tokens with functions performed by standard cells serves to abstract the logical or operational view of the circuit from its raw image. This abstraction enables the creation of the list of cell placements in the IP core design. At a rudimentary level, the placement list comprises a catalog of the logical view or operational view description of each instance of a standard cell with its location and orientation on the die.

The process of registering the vias on the first metallization layer to the vias on the higher metallization layers, then associating the locations on the first metallization layer of all the termini connected the metal traces serves to identify the interconnections among the cells. This information, combined with the connections to signal leads enables the reconstruction the routing list. At a rudimentary level, the routing list comprises the coordinates of all the nodes of each standard cell instance that connects to other standard cells or data lines and coordinates of the termini of those connections. This information then may be organized in a format consistent with an industry standard used in electronic design automation for specifying the routing network for a circuit design such as a Cadence Design Exchange Format (DEF) file, for example.

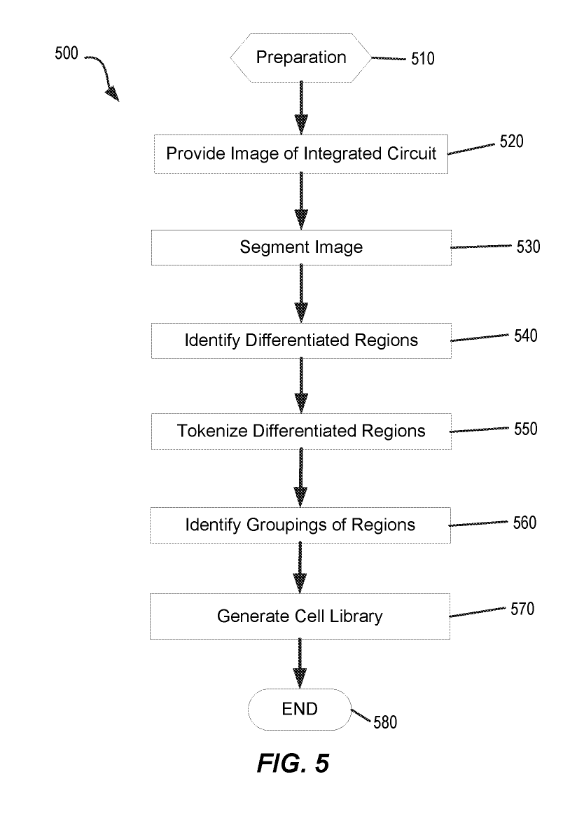

FIG. 5 is a flow chart of process 500 further detailing process 300 for identifying and tokenizing standard cells in order to extract the layout-functional relationships of an integrated circuit. Process 500 begins with preparation step 510, which may include decapsulation and delayering of the die, determination of appropriate imaging technology and selecting the appropriate image magnification. In step 520 an image of an integrated circuit is provided, such as by capturing the image using an imaging device. This image may be any portion of the integrated circuit, an individual image tile, or multiple tessellating image tiles that capture the entire circuit. Multiple images may be required to capture a single circuit block because of the need to resolve image detail in the micro-scale regions while also identifying associations among differentiated regions on the scale of an entire circuit block. In step 530, the provided image may be segmented according to the functional layout. For example, the power and ground busses between rows (alternatively columns) of cells may be segmented from the cells. From the segmented image, in step 540 the plurality of differentiated regions that make up the cells are identified and converted from complex bitmapped descriptions to simplified vectorized forms, which speeds identification of equivalent forms in the next step. In step 550, the equivalent differentiated regions may be identified and their vector forms tokenized, which more readily supports the identification of repeated spatial groupings in the circuit at each stage in the hierarchical reconstruction of the cell layout. Following tokenization of the associated regions, in step 560 one or more tokens for associated differentiated regions may be associated into higher-order hierarchical layout-functional groupings and again tokenized. Step 560 may continue until further grouping of tokens results in no further reduction in the cost function for associating regions. Next, in step 570, a cell library may be generated by compiling the identified distinct groupings of differentiated groupings along with the vector forms that describe their layout in a database such as a Cadence LEF file. Process 500 terminates with step 580 wherein any finalizing process steps may be performed such as recording for future recall details of any of the specific subprocesses of the abovementioned steps.

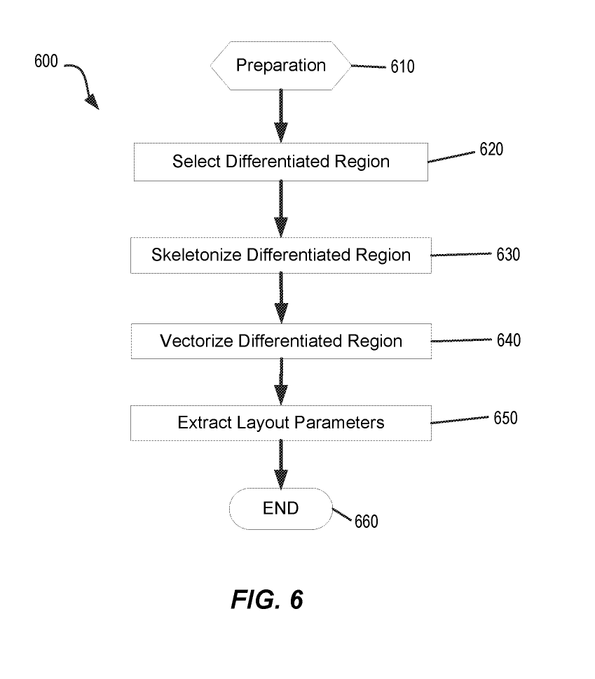

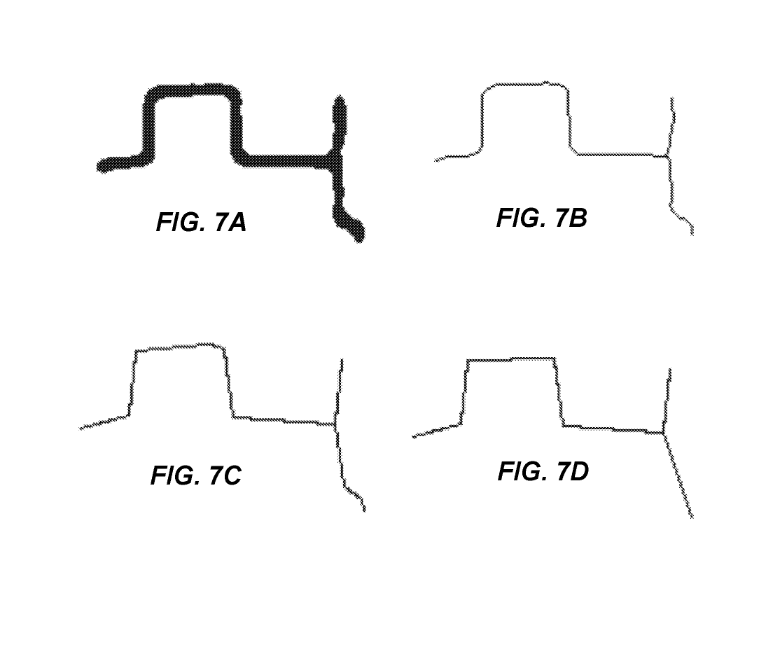

FIG. 6 is a flow chart further detailing process 500, including extraction of the foundry rules for an integrated circuit layout. Process 600 begins with preparation step 610, which may include execution of various steps of processes 300 and/or 500 as described above. Next each individual differentiated region is selected in step 620. Selection may be done after the image is segmented according to the functional layout. For example, the power and ground busses between rows (alternately columns) of cells may be segmented from the cells. The selected region at this step may now be a bitmapped image. In step 630, this bitmapped image may be image processed via a process such as erosion to result in a simplified region. The simplified region may be a dimensionally reduced form, such as a medial axis skeleton, for example, described in association with FIG. 7B below for metallization regions, or it may be an exterior boundary contour for a doped region. During the process of dimensional reduction, the size of the reduction required to achieve the simplification may be measured, providing information about the critical dimensions of the process (e.g., the width of the metal traces or size of the doped regions). Next in step 640, the simplified region may be vectorized or polygonized, resp., in order to facilitate faster computation of the topologically equivalent forms in the hierarchy of layout refinements. This hierarchy may include the design of the standard cells, the layout variations associated with different lithography scales, and the foundry rules imposed on the size and spacing of regions by the semiconductor manufacturing process. In step 650 layout parameters may be measured or determined from values extracted from the simplified regions during the vectorization and/or polygonization process of step 640. In step 660, process 600 terminates and wherein any finalizing process steps may be performed such as recording of any of the details of the previous steps of process 600 into a database structure for future recall, such as a Cadence LEF file that describes the critical dimensions of and spacings between the metallization regions.

FIGS. 7A-D show a set of images representing details of tokenizing process 600 of FIG. 6. FIG. 7A shows an image of an individual differentiated region from a segmented image of the first metallization layer of an integrated circuit selected, for example, during step 620 of process 600. The region of FIG. 7A is at this stage a complex bitmapped image. FIG. 7B shows an image of the individual differentiated region eroded and simplified into a medial-axis line form such as by step 630 of process 600. During step 630 additional processing may be applied to remove spurious features subject to predetermined criteria. FIG. 7C shows an image of the eroded form of FIG. 7B where the complexity of the form has been further reduced by substitution of straight line segments for portions of the medial-axis line form according to predetermined criteria. The substitution may be performed by first locating vertices within the form in FIG. 7B. These vertices include end points, angle points and junction points. An end point may be identified as a point that has only one contiguous nearest neighbor point in an adjacent pixel. An angle point may be identified as a point about which a circle whose radius exceeds a minimum threshold may be drawn that intersects two sequences of points whose respective best straight line fits subtend an angle that exceeds a minimum threshold value. A junction may be identified as a point about which a circle whose radius exceeds a minimum threshold may be drawn from which more than two sequences of points emerge. Located vertices may then be joined by straight lines and produce the form as shown in FIG. 7C.

FIG. 7D shows an image of the vectorized form of FIG. 7C wherein further simplification has been achieved by combination and substitution of resultant small angled line segments with approximate longer straight line segments. The image of FIG. 7D represents a multiple order reduction in the complexity of representation of and comparison to the identified region. For metallization layers this reduction is considered in light of the constraints imposed by layout editors that typically reduce a region to a polygon comprising straight line segments joined only at angles of 45° and 90° The simplification of FIG. 7D retains the essential topological characteristics of FIG. 7A, which are sufficient to distinguish the individual regions identified in an image.

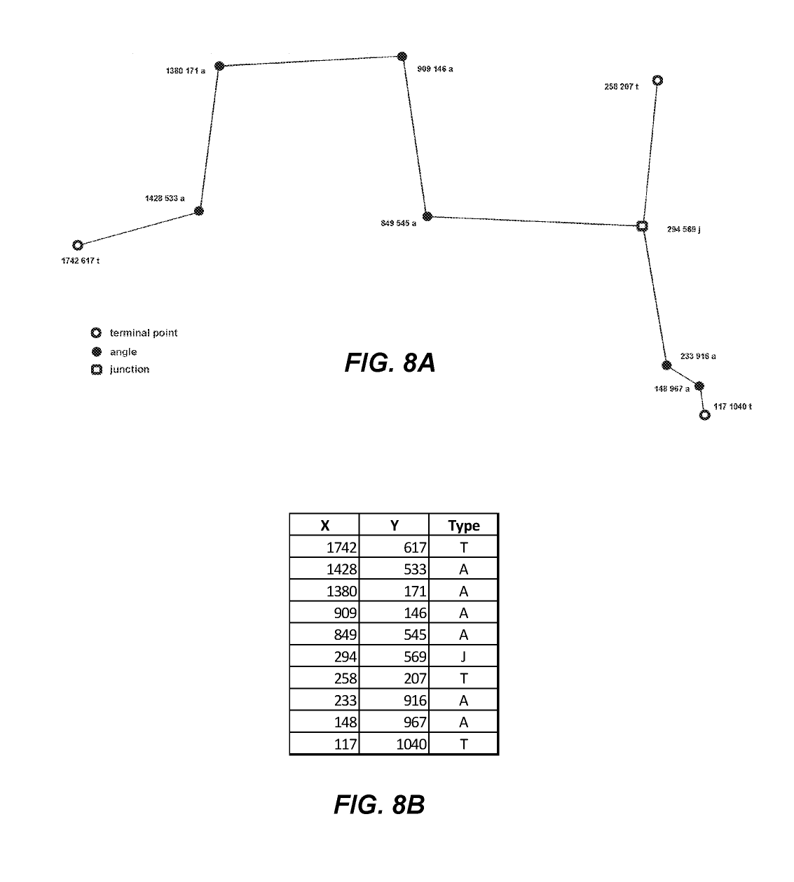

FIG. 8A shows an annotated graphical representation of the results of the vectorization process of FIG. 6 for the differentiated region of FIG. 7. In FIG. 8B, a tabular (computer database) representation of the region is shown. Here the hundreds of individual bitmapped values defining the original bitmapped image of FIG. 7A have been reduced to a table of 10 coordinate pairs and intersection types; this format is consistent with the PATH syntax used in LEF files to specify the layout metal traces, which here serve to describe differentiated regions in a standard cell. It should be noted that this information alone is sufficient to characterize the layout of a circuit region, without requiring that a tokenized representation of the image be generated. Producing a tokenized representation of the contents of an image is illustrative of the processes of the current invention and is useful for human interaction/review of the result.

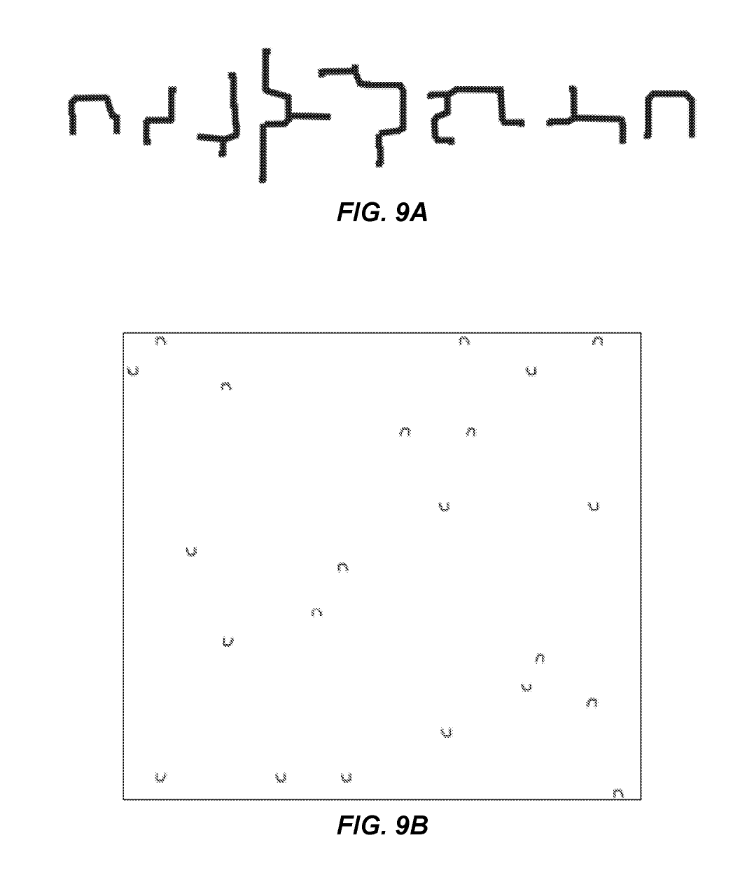

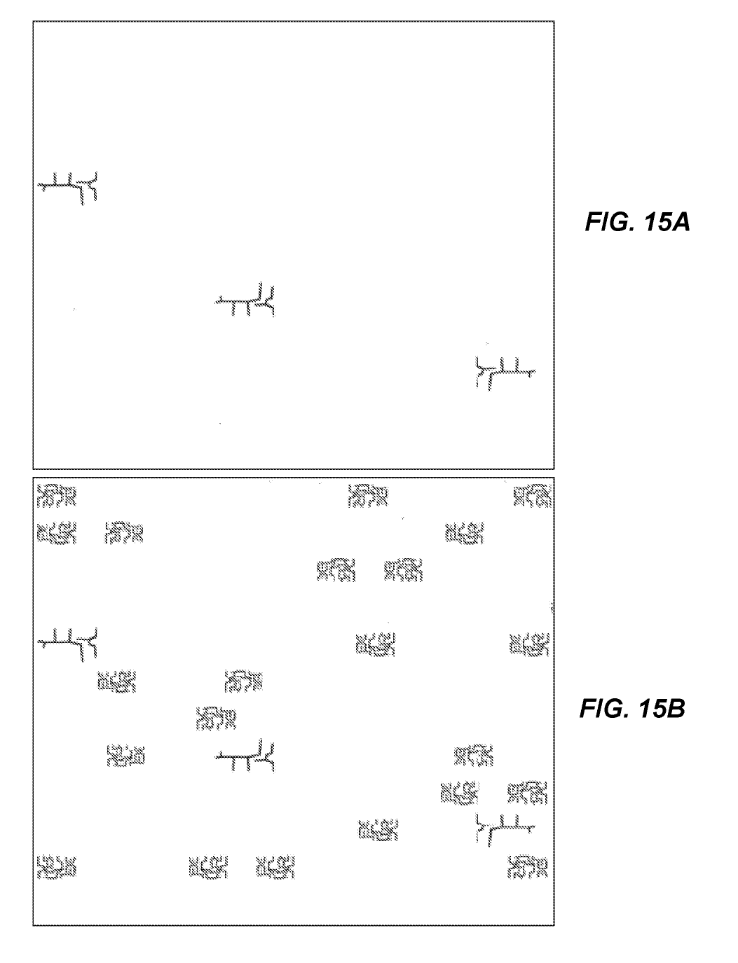

FIG. 9A is a visual depiction of a set of 8 tokens representing the inequivalent differentiated regions identified in the image of the integrated circuit of FIG. 4A using the processes of FIGS. 5 and 6. The content of FIG. 4 has been reduced to these 8 tokens and a description of their locations and orientations in the original image of FIG. 4A. FIG. 9B is the image of the integrated circuit of FIG. 4A indicating locations and orientations of only the first identified token. This simple token may, for example, represent an enclosure around a signal input within a CMOS D-type flip-flop (DFF), or a similar simple logic element such as a NAND gate, NOR gate, or NOT circuit. Another example of the tokens associated with particular functional operations appears in FIG. 15A, where the grouping of two other identified tokens may represent the interdigitated electrodes of a metal-oxide-metal (MOM) capacitor, for example.

FIG. 10 is a flow chart of process 1000 for identifying and tokenizing hierarchical structure-functional relationships of an integrated circuit. Process 1000 begins with preparation step 1010 in which the vectorized representations of all differentiated regions output by process 600 may be aggregated and indexed, and it may produce as output the tokenized set of distinct differentiated regions as presented in FIG. 9A. In step 1020, a similarity matrix, for example a covariance matrix, for all the differentiated regions that appear in the image may be generated by calculating the similarity between every indexed pair of regions and thresholding the results of the similarity calculation. Similar regions then may be consolidated in step 1030 by equating them to their average representation. For example, the measure of topological similarity between two tokens may be defined by the sum of the absolute value of the difference in the number of end points, angles and junctions, respectively, between the two tokens. Alternatively, Euclidean distance metrics between the coordinate points may be used.

The averaged representatives of each differentiated region may then serve as the token for that shape, and the token or a symbol thereof substituted back into the image in step 1040 as a placeholder for each instance of that differentiated region. Subsequently, in steps 1050 and 1060, the tokens in the image may be associated in groups by iteratively pairing neighboring tokens according to proximity and frequency of pairing occurrence in the image, then re-tokenizing the pairings and associating the composite tokens, thereby producing a hierarchy of token groupings from which higher orders of structure-functional relationships may be inferred. The iterative process continues via loopback path 1080 until an equilibrium is reached in step 1070 when further re-grouping does not provide additional simplification, as calculated, for example, according to a complexity cost function that rewards grouping according to proximity and frequency of occurrence, but penalizes distance between grouped regions. In step 1090, process 1000 terminates and wherein any finalizing process steps may be performed such as recording of any of the details of the previous steps of process 1000 into a database structure for future recall. By the above-described processes, recurring groupings of differentiated metallization regions may be identified as corresponding to standard cells. Related determination of cell placement and routing of leads to and between the cells also extracted using these processes may be used for reconstructing the Netlist and the PDK of the integrated circuit of interest.

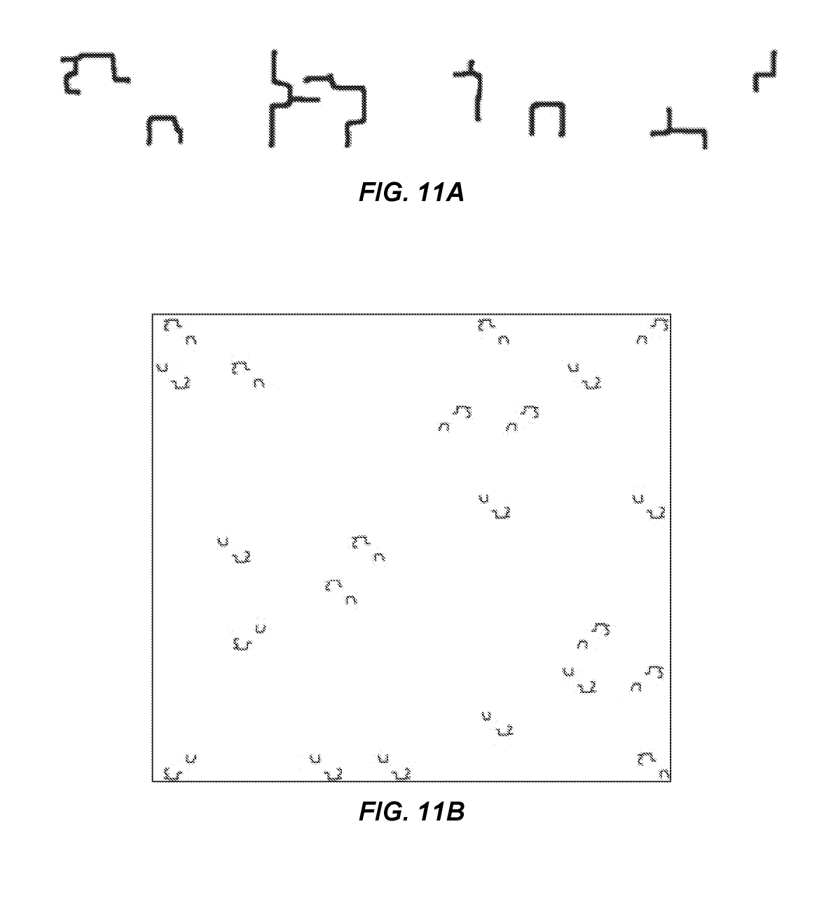

FIG. 11A shows an image of a set of four token pairings identified by the procedure of FIG. 10 in the image of the integrated circuit of FIG. 4. FIG. 11B is an image of the integrated circuit of FIG. 4A that shows the locations and orientations of only the first identified token pairing. Identifying and locating these paired tokens may be considered the first iteration of steps 1050, 1060, 1070, 1080 in process 1000.

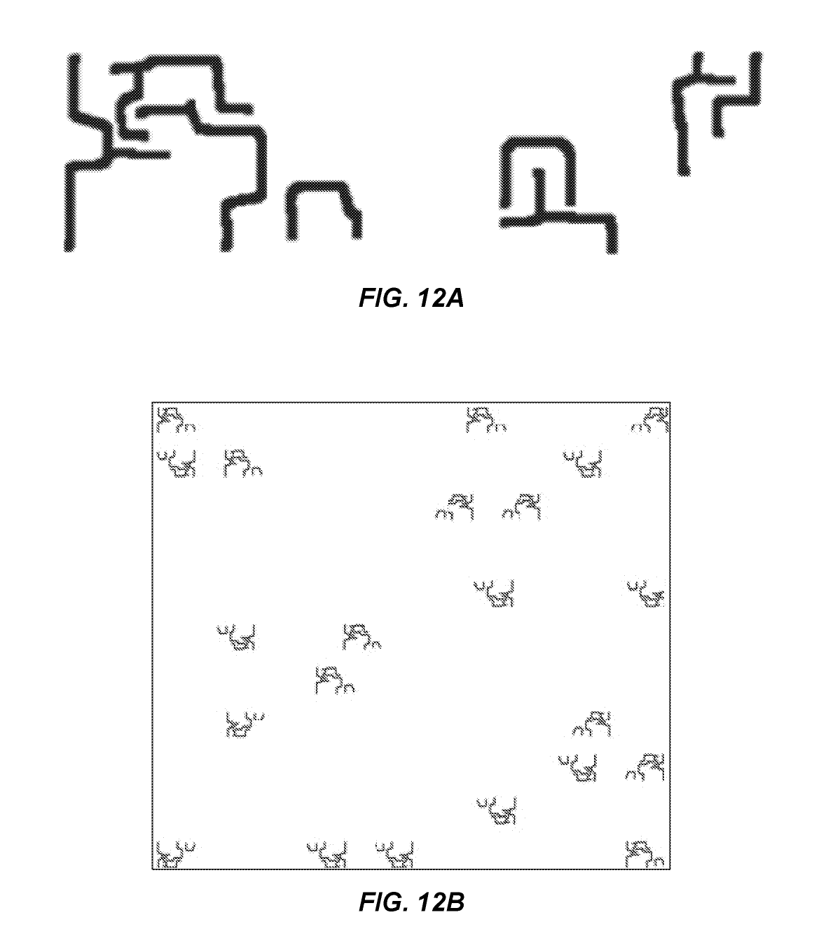

FIG. 12A shows an image of a set of second-order token groupings identified in the image of the integrated circuit of FIG. 4. FIG. 12B is the image of the integrated circuit of FIG. 4A indicating locations and orientations of only the first identified second-order token grouping. The identification and locating of these doubly-paired tokens may be considered the second iteration of steps 1050, 1060, 1070, 1080 in process 1000.

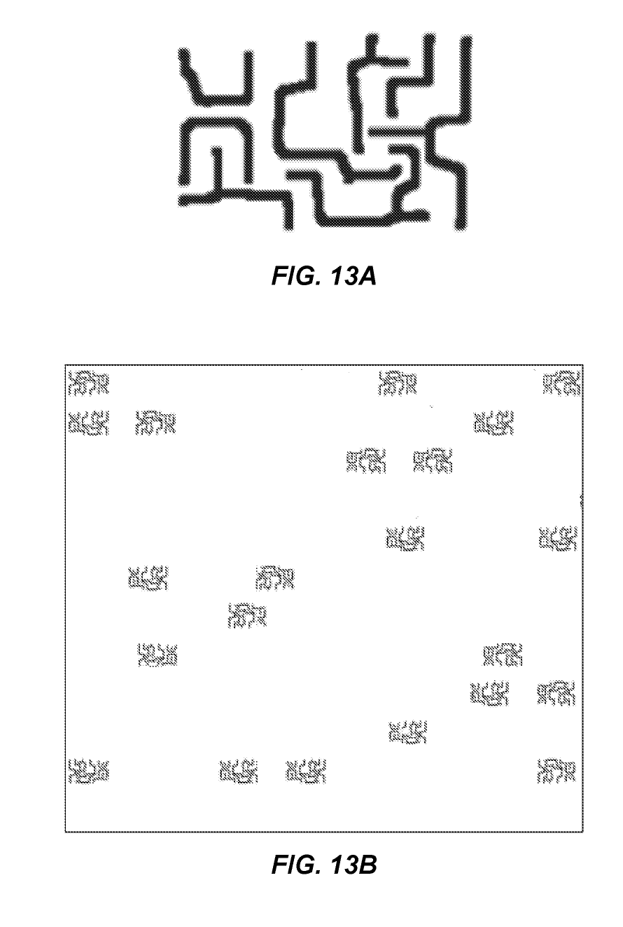

FIG. 13A shows an image of a higher-order token grouping identified in the image of the integrated circuit of FIG. 4. FIG. 13B is the image of the integrated circuit of FIG. 4A indicating locations and orientations of only the higher-order token grouping of FIG. 13A. The identification and locating of these multi-token groupings may be considered the third iteration of steps 1050, 1060, 1070, 1080 in process 1000. Although in this example only three passes of the iteration have been represented, it should be understood that pairing and further iteration may be performed until an equilibrium is reached where further grouping does not provide additional simplification. Furthermore, although a pairing process is described herein, it should be understood that the iterative grouping may be performed upon any whole number of elemental or grouped tokens.

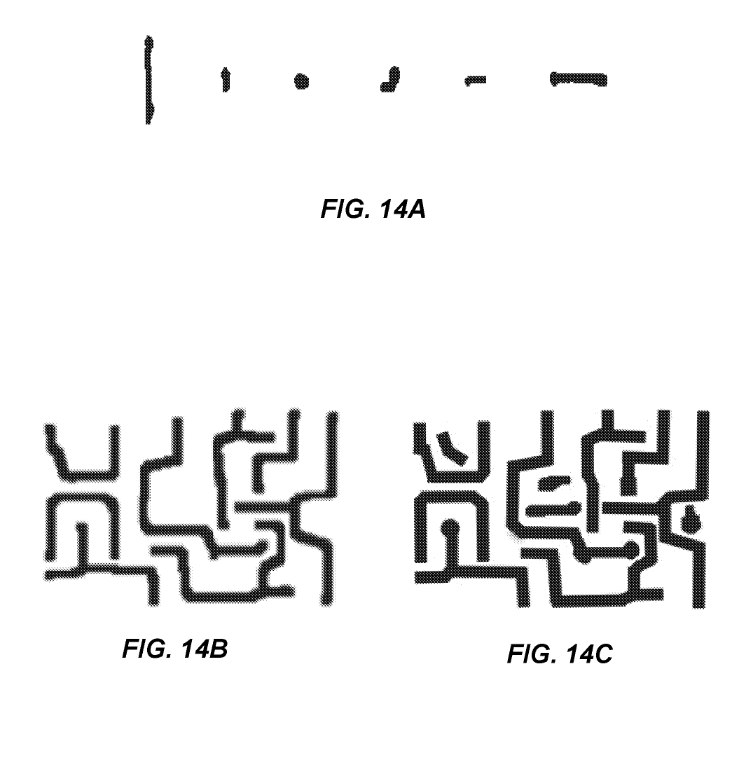

FIG. 14A shows a set of tokenized differentiated regions identified from the image of the integrated circuit of FIG. 4A representing primitive interconnect elements, such as appear in filler cells. FIG. 14C is an image of the higher-order token grouping combined with its associated primitive interconnect-element tokens, such as might represent a D-type flip-flop (DFF), for example. FIG. 13A (labeled as FIG. 14B) has been reproduced proximate FIG. 14C for convenience in comparing the addition of and registration between the interconnects and group tokens.

FIG. 15A is the image of the integrated circuit of FIG. 4A indicating locations and orientations of only a second further higher-order paired token, such as might represent a metal-oxide-metal (MOM) capacitor. FIG. 15B is a union of the images of FIGS. 13B and 15A showing the spatial relationships amongst the higher-order identified token groupings. Inspection of the tokens appearing in FIG. 15A makes evident the multiple possible orientations of a given token grouping. During the tokenizing process, the equivalence of tokens regardless of orientation is considered and is utilized to increase the compression of the tokenized information.

FIGS. 16A-D are images of portions of successive metallization layers of an integrated circuit indicating processing steps of identifying routing-layout relationships of the integrated circuit. Specifically, FIG. 16A is an image of the integrated circuit of FIG. 4C indicating locations of vias that connect metallization layer 1 to metallization layer 2. FIG. 16B is an image of the second metallization layer of the integrated circuit of FIG. 4C showing the inter-row (vertical) interconnects between the components of the integrated circuit of FIG. 4C. FIG. 16C is an image of the integrated circuit of FIG. 4C indicating locations of vias that connect metallization layer 2 to metallization layer 3. FIG. 16D is an image of the third metallization layer of the integrated circuit of FIG. 4C showing the intra-row (horizontal) interconnects between the components of the integrated circuit of FIG. 4C. The termini of the differentiated regions in the images of metallization layer 2 may be registered to the vias in the first metallization layer shown in FIG. 16A, and the termini of the differentiated regions in the images of metallization layer 3 may be registered to the vias in the second metallization layer shown in FIG. 16C, resp. Grouping, tokenizing and associating of features across multiple layers directly supports expansion of the hierarchical functionality determination to 3D structures.

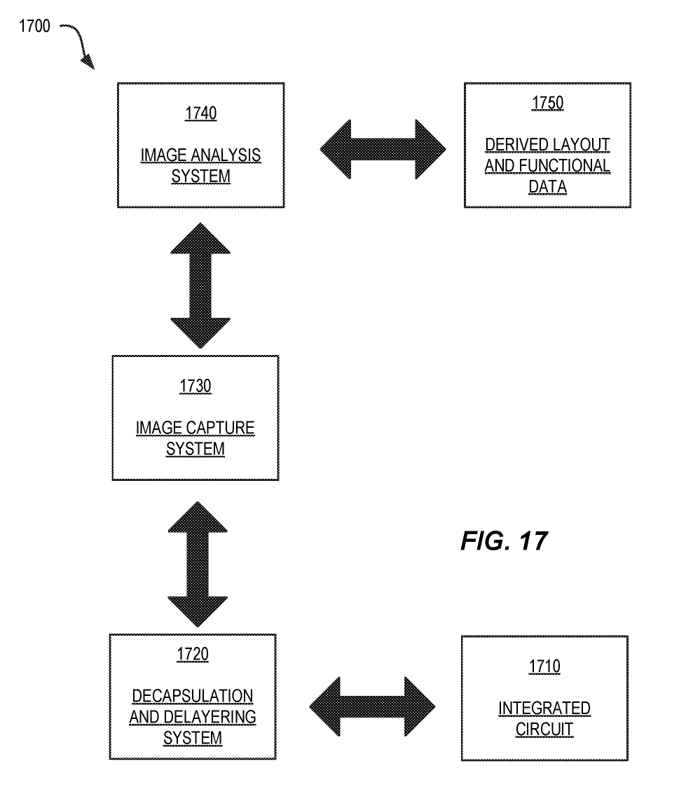

FIG. 17 is block diagram of major system elements of an exemplary reverse engineering system operational to collect integrated circuit images and analyze those images to provide layout and functional data. Integrated circuit 1710, which may be any type of device as described herein may be decapsulated and delayered with decapsulation and delayering system 1720. The decapsulated integrated circuit and each subsequent delayering of the circuit may be imaged at the required resolution to resolve the features of interest in each layer with image capture system 1730, such as a SEM system, as described in association with process 300. One or more images captured by image capture system 1730 may be analyzed according to any or all of processes 300, 500 and 600 by image analysis system 1740. Image analysis system 1740 includes, for example, a processor and a memory (not shown), where the processor executes instructions in the form of software or firmware stored in the memory to execute one or more of processes 300, 500, and 600, and 1000. Resultant derived layout and functional data 1750 may be stored and/or utilized in subsequent analyses and comparison as described herein.

The results derived from the procedure in the preceding paragraphs may be used to compare integrated circuits for the purpose, inter alia, of determining whether the integrated circuits incorporate a common IP core or cores, both for hard and soft cores. The placement netlist for each IC core provides a symbolic representation of the core's design that is sufficient to identify the core independently of the PDK used in its design and without requiring that the functionality of the identified cells be determined. Simply matching the pattern of cell occurrences in the cores is sufficient to identify equivalent cores on different ICs in a manner that is transparent to cell design and foundry rules.

Analogously, cores that have been modified so as to incorporate altered or malicious capabilities not present in the original design also may be identified by comparing the pattern of cells in the placement netlist of the suspect core to the pattern of cells in the placement netlist of the authentic core design. Pattern mismatches between the two cores indicate the presence of modifications to the function of the core in a manner that is transparent to cell design and foundry rules.

Because the Process Design Kit contains information that is specific to a particular fabrication process, viz., the design of the standard cells and the rules governing their physical layout, the methods of analysis of the functional layout of an IC described herein also may be used to determine the origin of an integrated circuit. A library may be compiled for the PDKs from multiple foundries, either using the proprietary design tools supplied to integrated circuits designers by the foundry for known foundries, or by deriving the cell library and foundry rules by analyzing integrated circuits that have been fabricated at an unknown foundry. The PDK of the unsourced integrated circuit may be derived according to process described herein. The design and layout of the standard cells in the unsourced integrated circuit may then be compared to standard cells ascribed to each foundry in the PDK library by applying the similarity metrics that are used in the tokenization of cells to generate a similarity matrix between the cells from the unsourced integrated circuit and the cells from each foundry represented in the PDK library. The likelihood that the unsourced integrated circuit was produced at a particular foundry represented in the PDK library may be determined by aggregating and normalizing the similarity values of the unsourced integrated circuit relative to a particular foundry.

In a similar manner, the elemental functions performed by the cells in an unknown core may be identified by comparing the cells to a library of known cell designs. If the foundry that fabricated the integrated circuit containing the unknown core is known, the cells are compared the cells in the PDK for that foundry; If the foundry that fabricated the IC containing the unknown core is not known, the cells are compared to the cells for each foundry in the PDK library. The comparison is made by applying the same similarity metric used to tokenize cells to each cell from the unknown core and every cell in a reference foundry's PDK to generate a similarity matrix. When the similarity between two cells exceeds a prescribed threshold, the elemental function performed by the unknown cell is identified as the function ascribed to the cell in the reference foundry's PDK.

The changes described above, and others, may be made in the functional reconstruction methods described herein without departing from the scope hereof. For example, although certain examples are described in association with metallization layers, it may be understood that the functional reconstruction methods described herein may be adapted to other types of objects such as blood cell patterns, agrarian/field process monitoring/planting/growth, crowd monitoring, and other systems incorporating hierarchical patterns and ordering, and based upon underlying rules like integrated circuit lithographic design rules.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method of identifying layout-functional relationships of an integrated circuit comprising:
providing a first image of at least a portion of a first layer of the integrated circuit;
processing the first image to identify at least two differentiated regions;
associating the differentiated regions; and
inferring at least one layout-functional relationship between the associated differentiated regions.

2. The method of claim 1, said providing said first image further comprising:
capturing said first image at a resolution capable of resolving the differentiated regions of the integrated circuit on the scale of a lithographic process used in fabrication of the integrated circuit.

3. The method of claim 1, wherein said first image is selected from the group consisting of visible light images, NIR images, fluorescence images, SEM images, STM images, profilometric images, SIMS, AFM, e-beam, and X-ray images.

4. The method of claim 1, said wherein said differentiated regions are selected from the group consisting of metallized regions, doped regions, via regions, interlayer interconnects, intralayer interconnects, chemically differentiated regions, and material-composition differentiated regions.

5. The method of claim 1, further comprising:
segmenting said first image;
identifying sets of like differentiated regions within the segmented image; and
tokenizing each identified set of differentiated regions.

6. The method of claim 5, further comprising:
identifying groupings of differentiated regions; and
generating a cell library.

7. The method of claim 5, further comprising:
selecting a differentiated region of the at least two differentiated regions;
skeletonizing an image of the selected differentiated region; and
vectorizing the image of the selected differentiated region to identify like regions for tokenization.

8. The method of claim 6, further comprising:
extracting layout parameters.

9. The method of claim 7, further comprising:
calculating a similarity matrix for the identified differentiated regions using a topological similarity metric;
consolidating component pairs of differentiated regions by equating regions whose topological similarity in the similarity matrix exceeds a threshold value;
substituting tokens for consolidated component pairs in the first image;
associating tokens using a cost function;
re-tokenizing associated tokens; and
iteratively consolidating, substituting, associating, and re-tokenizing until a cost function is minimized.

10. The method of claim 1, further comprising:
providing a second image of at least a portion of a first layer of the integrated circuit;
processing the second image to identify at least two second differentiated regions;
associating the second differentiated regions; and
comparing the first and second associated differentiated regions using a similarity metric.

11. The method of claim 6, further comprising:
associating groupings of regions with their design function in the integrated circuit.

12. The method of claim 1 wherein the differentiated regions are electrical connections between integrated-circuit sub-elements.

13. The method of claim 1 further comprising:
providing a set of standard cells used to implement the elemental design functions of the integrated circuit; and
identifying the functionality of a standard cell of the set of standard cells via a relationship between the association of differentiated regions; and
determining a mathematical similarity or difference between said association of differentiated regions and said set of standard cells.

14. The method of claim 7, further comprising:
providing a second image of at least a portion of a second layer of the integrated circuit;
processing the second image to identify at least one differentiated region;
spatially registering the termini of the differentiated regions of the second image with the first image; and
deriving the interconnections between the differentiated regions of the first layer from their association with the differentiated regions in the second layer.

15. The method of claim 6, further comprising:
determining a cell placement list from analysis of the associations of the differentiated regions.

16. The method of claim 14, further comprising:
determining the routing network from the registration of vias associated with the differentiated regions in the first layer with the termini of differentiated regions in the second and higher layers.

17. The method of claim 1, further comprising:
extracting at least one of foundry, design rule, and functional information from analysis of the associations of the differentiated regions.

18. The method of claim 17, further comprising:
comparing the at least one of foundry rules, design rules and functional information from analysis of the associations of the differentiated regions to the same from one or more other known foundries using a similarity metric; and
determining the foundry that fabricated the integrated circuit.

19. A system for reverse engineering an integrated circuit comprising:
an imaging system configured to collect an image of the integrated circuit; and
a processor configured to (a) identify at least two differentiated regions of the image, (b) associate the differentiated regions, and (c) infer at least one layout-functional relationship between the associated differentiated regions.

20. A method for determining provenance of an integrated circuit comprising:
providing an image of at least a portion of a layer of the integrated circuit;
processing the image to identify at least two differentiated regions;
extracting at least one of foundry, design rule and functional information from analysis of associations of the differentiated regions; and
comparing the extracted information with a predetermined set of references.
